(19) United States
(12) Patent Application Publication
(10) Pub. No.: US 2015/0102649 A1
(43) Pub. Date: Apr. 16, 2015

(54) LEG SUPPORT FOR VEHICLE OCCUPANT

(71) Applicant: Mohamed Ali Baig, Scarborough (CA)

(72) Inventor: Mohamed Ali Baig, Scarborough (CA)

(21) Appl. No.: 14/575,422

(22) Filed: Dec. 18, 2014

Related U.S. Application Data
(63) Continuation-in-part of application No. 13/758,333, filed on Feb. 4, 2013, now Pat. No. 8,939,514.

(51) Int. Cl. B60N 2/44

(52) U.S. Cl. CPC B60N 2/4495; B60N 2002/4425
USPC 297/423.1

(57) ABSTRACT

Described are leg supports for a vehicle occupant having a leg support base and a leg engagement member that is positionable to support the lower leg of the vehicle occupant such that the upper leg and the lower leg extend in a common plane that is substantially parallel to the sagittal plane of the vehicle occupant. According to one aspect, the leg support includes a guide configured to mount to a center console in a selected position relative to a vehicle seat in a vehicle, the leg support base being slidably mounted to the guide, and to provide adjustment of a position of the leg engagement member through sliding movement of the leg support base relative to the guide. According to another aspect, the leg support includes a pump coupled to the leg support base to provide a fluid to at least partially fill the leg engagement member.

### CROSS-REFERENCES TO OTHER APPLICATIONS

This application is a continuation-in-part of U.S. patent application Ser. No. 13/758,333, filed on Feb. 4, 2013, now pending, the entire contents of which are incorporated by reference.

### FIELD

The disclosure generally relates to the art of leg supports for vehicle occupants.

### BACKGROUND

It is known to provide leg supports for use by a vehicle driver that permit the occupant's leg to be supported while driving. Some proposed leg supports, however, suffer from several problems. Some are relatively complex structures that are also relatively expensive. Some are relatively ineffective at supporting the leg of the driver.

It would be advantageous to provide a leg support that at least partially overcomes one or more of the aforementioned problems.

### SUMMARY

This section provides a general summary of the disclosure, and is not a comprehensive disclosure of its full scope or all of its features.

In an aspect, a leg support for a vehicle occupant is provided, and includes a leg support base and a leg engagement member. The leg support base is connected (or is connectable) to a center console of the vehicle. The leg engagement member may be integral with the leg support base or may be extendable from the leg support base. The leg engagement member is configured to engage the laterally outer face of a lower leg of a vehicle occupant. The leg engagement member has a leg engagement surface that has a lower edge and an upper edge. The lower edge is positioned to engage the lower leg of the vehicle occupant above the lateral malleolus of the fibula of the vehicle occupant. The upper edge is positioned to engage the lower leg of the vehicle occupant above a midpoint of the fibula and below the superior epiphysis of the fibula. The leg engagement member is positionable to support the lower leg of the vehicle occupant in such a way that the upper leg and the lower leg extend in a common plane that is substantially parallel to the sagittal plane of the vehicle occupant.

In another aspect, there is provided a leg support for a vehicle occupant having a leg support base and a leg engagement member that is adjustable in position relative to the leg support base. The leg engagement member has a leg engagement surface that extends generally parallel to a sagittal plane of a vehicle occupant in the vehicle seat so as to be positioned to engage the laterally outer face of a lower leg of the vehicle occupant, wherein the leg engagement surface is positioned to engage the lower leg of the vehicle occupant above the lateral malleolus of the fibula of the vehicle occupant and to engage the lower leg of the vehicle occupant above a midpoint of the fibula and below the superior epiphysis of the fibula, and wherein the leg engagement member is positionable to support the lower leg of the vehicle occupant in such a way that the upper leg and the lower leg extend in a common plane that is substantially parallel to the sagittal plane of the vehicle occupant. The leg support further includes a guide configured to mount to a center console in a selected position relative to a vehicle seat in a vehicle, the leg support base being slidably mounted to the guide, and the guide being configured to provide adjustment of a position of the leg engagement member through sliding movement of the leg support base relative to the guide.

In another aspect, there is provided a leg support for a vehicle occupant. The leg support includes a leg support base configured to mount to a center console in a selected position relative to a vehicle seat in a vehicle and a leg engagement member that is adjustable in position relative to the leg support base. The leg engagement member has a leg engagement surface that extends generally parallel to a sagittal plane of a vehicle occupant in the vehicle seat so as to be positioned to engage the laterally outer face of a lower leg of the vehicle occupant, wherein the leg engagement surface is positioned to engage the lower leg of the vehicle occupant above the lateral malleolus of the fibula of the vehicle occupant and to engage the lower leg of the vehicle occupant above a midpoint of the fibula and below the superior epiphysis of the fibula, and wherein the leg engagement member is positionable to support the lower leg of the vehicle occupant in such a way that the upper leg and the lower leg extend in a common plane that is substantially parallel to the sagittal plane of the vehicle occupant. The leg support further includes a pump coupled to the leg support base and configured to draw a fluid from a reservoir and a pump motor for driving the pump. The leg engagement member has at least one orifice coupled to the pump through which the fluid is provided to the leg engagement member. The pump motor is configured to electrically couple to a power source for the pump. A pump controller is also included.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The foregoing and other aspects will be more readily appreciated having reference to the drawings, wherein:

FIG. 1 is a perspective view of a vehicle;

FIG. 2 is a plan view of a driver's portion of a passenger compartment of the vehicle shown in FIG. 1;

FIG. 3 is a plan view of the driver's portion of the passenger compartment shown in FIG. 2 showing a leg support supporting an inboard leg of a vehicle driver;

FIG. 4 is a magnified perspective view of the leg support;

FIG. 5 is a sectional view of the leg support;

FIG. 6 is a front view of the leg support engaged with a lower leg of a driver;

FIG. 6a is a magnified front view of the leg support engaged with the lower leg of the driver showing some of the anatomy of the lower leg;

FIG. 7 is a perspective view of a variant of the leg support;

FIG. 8 is a plan view similar to FIG. 3, showing a plurality of leg supports supporting an inboard leg of the vehicle driver;

FIG. 9 is a perspective view of another embodiment of a leg support;

FIG. 10 is a perspective view of yet another embodiment of a leg support;

FIG. 11 is a perspective view of still another embodiment of a leg support; and

FIG. 12 is a sectional perspective view of the leg support shown in FIG. 11;

FIG. 13 is a top plan view of a component of the leg support shown in FIG. 10;

FIG. 14 is a perspective cutaway view of a portion of the leg support shown in FIG. 10;

FIG. 15 is a perspective view of an embodiment of a leg support having a guide to provide adjustment of a position of the leg engagement member;

FIG. 16 is a front view of the leg support shown in FIG. 15 engaged with a lower leg of a driver;

FIG. 17 is a magnified front view of the leg support shown in FIGS. 15 and 16 engaged with the lower leg of the driver showing some of the anatomy of the lower leg;

FIG. 18 is a front view of the leg support shown in FIG. 15;

FIG. 19A is a perspective view of another embodiment of a leg support having a guide to provide adjustment of a position of the leg engagement member;

FIG. 19B is the perspective view the embodiment of a leg support having a guide to provide adjustment of a position of the leg engagement member in FIG. 19A showing a space over which the guide permits movement of the leg support;

FIG. 20 is a cut-away view of the embodiment of a leg support shown in FIGS. 19A and 19B;

FIG. 21 is a perspective view of another embodiment of a leg support having a guide to provide adjustment of a position of the leg engagement member;

FIG. 22 is a front view of an embodiment of a leg support having a pump for at least partially filling a leg engagement member of the leg support;

FIG. 23 is a front view of the leg support shown in FIG. 22 engaged with a lower leg of a driver;

FIG. 24 is a magnified front view of the leg support shown in FIGS. 22 and 23 engaged with the lower leg of the driver showing some of the anatomy of the lower leg;

FIG. 25 is a front view of another embodiment of a leg support having a pump for at least partially filling a leg engagement member of the leg support; and

FIG. 26 is a plan view of the driver's portion of the passenger compartment shown in FIG. 2 showing a leg support supporting an inboard leg of a vehicle driver.

### DETAILED DESCRIPTION

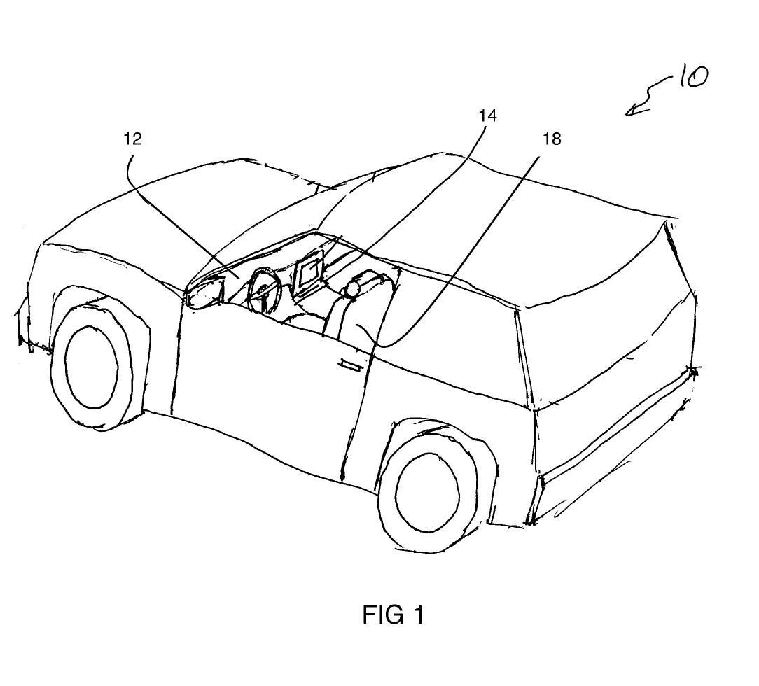

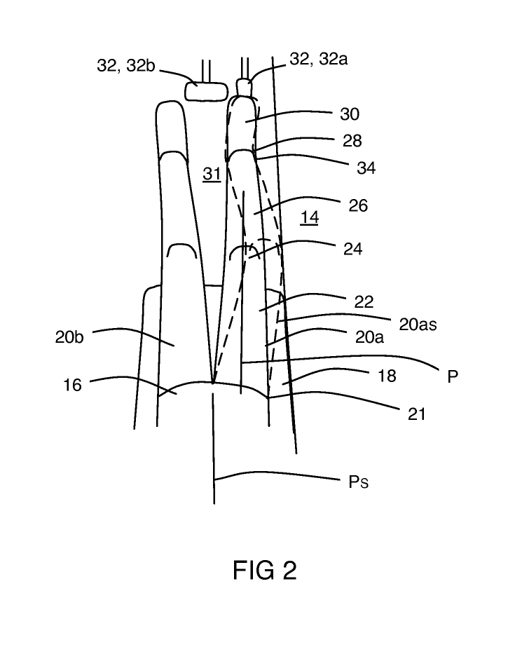

FIG. 1 is a perspective view of a vehicle 10 having a passenger compartment 12 and a center console 14 in the passenger compartment 12. Referring to FIG. 2, a vehicle driver 16 is shown sitting in the driver's seat, shown at 18. The driver 16 has two legs including an inboard leg 20a and an outboard leg 20b. The inboard leg 20a faces the center console 14. The inboard leg 20a is the right leg of the driver 16 on a left-hand drive vehicle, as shown, however it will be understood that the inboard leg 20a will be the left leg of the driver 16 on a right-hand drive car. Each leg 20 extends from a hip 21 and includes an upper leg 22, a knee 24, a lower leg 26, an ankle 28 and a foot 30.

Referring to FIG. 2, a plurality of pedals are shown at 32 and are provided within the driver's portion of the passenger compartment 12. The pedals 32 include an accelerator pedal 32a and a brake pedal 32b. Optionally, a clutch pedal is provided (not shown). In the vehicle 10 shown, the accelerator pedal 32a is nearer to the center console 14 and is thus the inboard pedal. In a case (not shown) where the vehicle 10 is a left hand drive vehicle the driver's inboard foot 30 may simply rest on a dead pedal on the vehicle floor shown at 31.

Referring to FIG. 2, in order to operate the accelerator and brake pedals 32a and 32b, the driver 16 may place the heel (shown at 34) of their foot 30 in one spot (e.g. in front of the accelerator pedal 32a) while rotating their foot 30 as needed to reach 32a and 32b. The position in which the heel 34 is placed may permit the lower leg 26 to be aligned with the upper leg 22 such that they extend in a common plane P that is substantially parallel to the sagittal plane of the driver 16, shown at P. Notwithstanding the presence of side bolsters on the driver's seat 18 in some vehicles 10, the driver 16 will need to exert some effort in order to hold their upper and lower legs 22 and 26 in the plane P and prevent the inboard leg 20a from splaying towards the center console under gravity, due to the lack of support on at least a portion of the upper leg 22 from the vehicle seat 18. After some time driving, the inboard leg 20a may fatigue from the effort and may undesirably splay towards the center console 14. The fatigue may be exacerbated by the repeated lifting and depressing of the driver's foot 30 and repeated rotation of the driver's ankle 28 to permit the foot 30 to switch which pedal 24 is being depressed.

The dashed outline shown at 20 as FIG. 2 is representative of the driver's inboard leg 20a splayed towards (and leaning against) the center console 14. As a result, the knee joint is bent at an angle that can cause strain to the knee 24 and also to other parts of the driver's body.

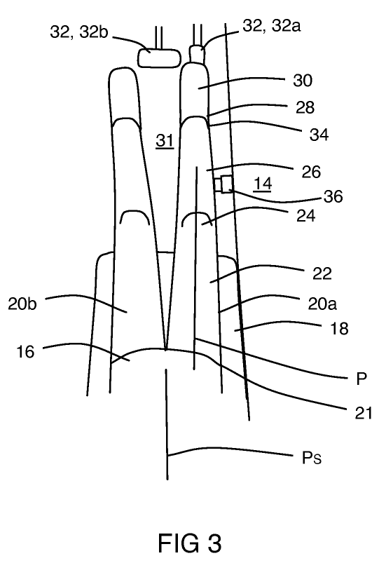

Referring to FIG. 3, a leg support 36 is provided and can hold the driver's inboard leg 20a so that the upper and lower legs 22 and 26 extend in the common plane P that is substantially parallel to the sagittal plane Pₛ of the driver 16. The leg support 36 may have any suitable structure. For example the leg support 36 may include a leg support base 38 and a leg engagement member 40. The leg support base 38 may connect to the center console 14 of the vehicle 10 in any suitable way. For example, in an embodiment, the leg support base 38 may removably connect to the center console 14 by way of an adhesive, thereby permitting the leg support 36 to be purchased as an after-market item by the owner of the vehicle 10. In another embodiment, the leg support base 38 may be permanently connected to the center console 14, optionally being installed by the vehicle manufacturer during assembly of the vehicle 10 or as an aftermarket item. The leg support base 38 may be made from any suitable material, such as a suitable polymeric material.

In an embodiment, the leg support base 38 has a generally cylindrical inner surface 42, which slidingly receives a generally cylindrical outer surface 44 on the leg engagement member 40. The leg engagement member 40 may be extendable from the leg support base 38. For example, the leg engagement member 40 may extend telescopically from the leg support base 38. Any suitable locking mechanism may be provided for holding the leg engagement member 40 at a selected position in the leg support base 38. For example, a locking pin (not shown) may extend through apertures (not shown) in the leg support base 38 and the leg engagement member 40 that are aligned with one another.

Instead of a locking pin and a plurality of apertures to provide adjustability in the position of the leg engagement member 40, the leg engagement member may have a threaded connection with the leg support base 38, such that the leg engagement member 40 may ‘unscrew’ to extend further from the leg support base 38, and may ‘screw in’ to retract into the leg support base 38. In yet another embodiment, the leg engagement member 40 may have a plurality of detents in its outer surface and the leg support base 38 may have a plunger or projection that is biased by a spring (e.g. a leaf spring) to engage whatever detent it is presented with. The driver may lift the projection to withdraw the projection from the detent it is engaged with against the biasing force of the spring to permit adjustment of the position of the leg engagement member 40 relative to the leg support base 38. Releasing the projection then permits it to reengage whatever detent it is facing. Alternatively any other suitable locking mechanism could be used.

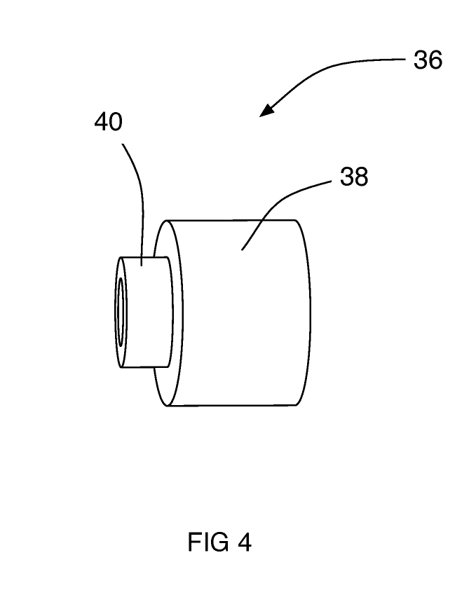

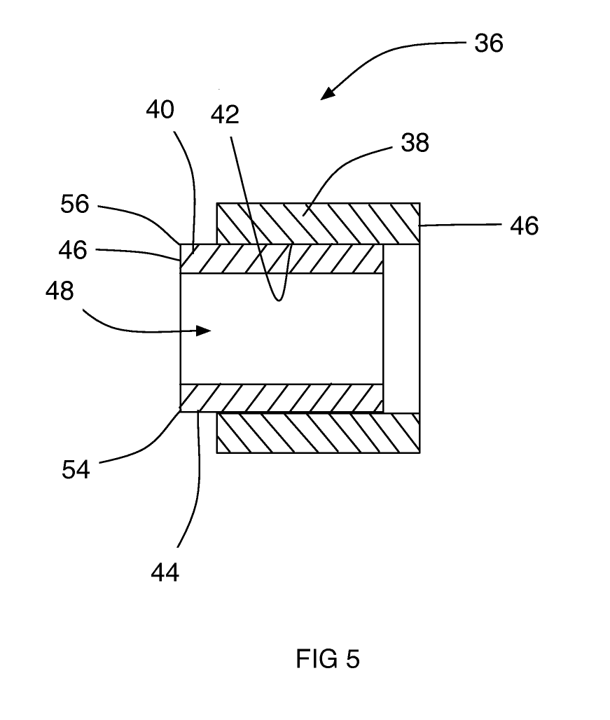

Referring to FIGS. 4 and 5, the leg engagement member 40 engages and supports the inboard leg 20a of the driver 16. The leg engagement member 40 may be made from a rigid, semi-rigid, or soft material. For example, the member 40 may be made from a suitable material such as an elastomeric material such as a closed cell foam material, or a gel-type material, such as is used in some modern mattresses.

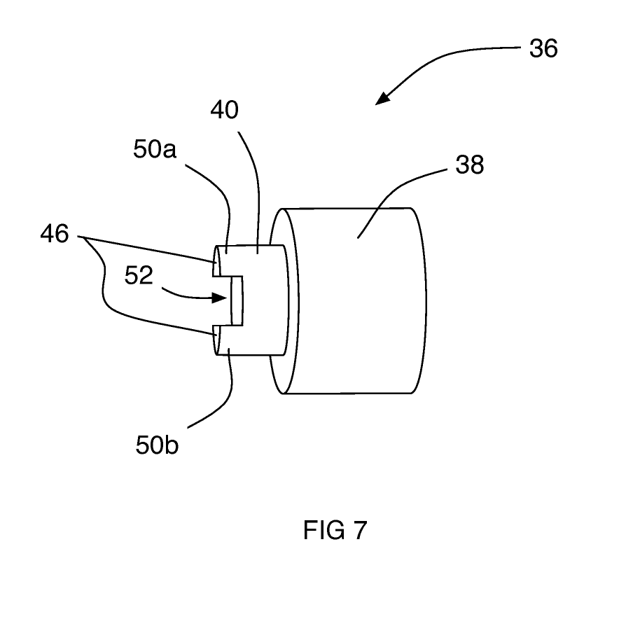

The leg engagement member 40 may have a leg engagement surface 46 that is a geometric shape surrounding an opening 48. By providing a geometric shape that is hollow (i.e. a shape that surrounds an opening), the leg engagement surface 46 engages a reduced amount of the driver's leg 20a while providing a relatively strong bracing effect on the leg 20a. It will be noted that the shape need not completely enclose the opening 48. For example, it is possible for the shape 46 to be formed by an upper engagement portion and a lower engagement portion that are spaced from one another by an opening 52, as shown at 50a and 50b in FIG. 7. In other embodiments, the leg engagement surface 46 need not be a hollow geometric shape but could instead be a shape with no opening therein. The leg engagement surface 46 has a lower edge 54 and an upper edge 56. In the embodiment shown in FIG. 4, the leg engagement surface 46 is generally annular.

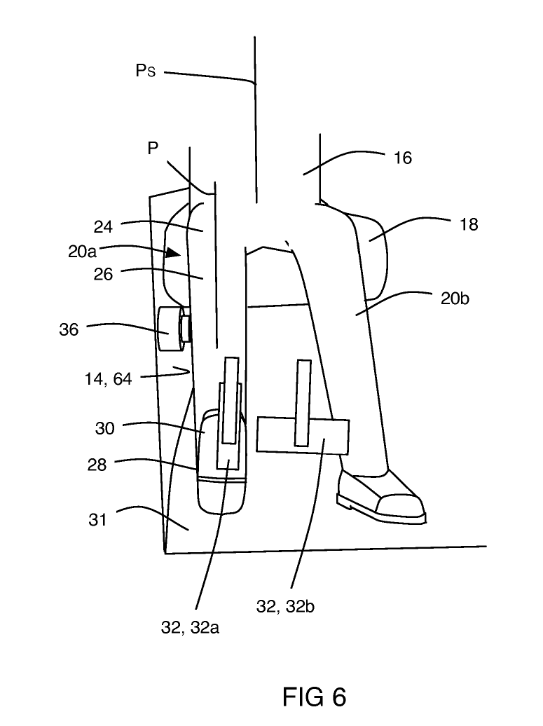

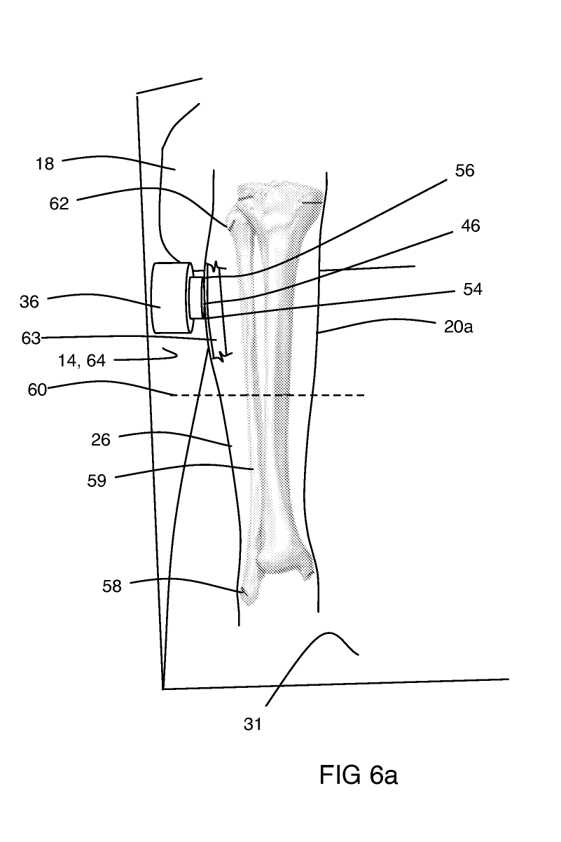

With reference to FIG. 6a, the leg support 36 is positioned to engage a specific portion of the leg 20a of the driver 16. In particular, the leg support 36 is positioned to engage the laterally outer portion of the lower leg, such that the lower edge 54 of the leg engagement surface 46 is above the lateral malleolus (shown at 58) of the fibula (shown at 59) and the upper edge 56 of the leg engagement surface 46 is above a midpoint (i.e. a halfway point) shown at 60 of the fibula 59 and below the superior epiphysis 62. In another embodiment the upper edge 56 of the leg engagement surface 46 is positioned to engage the peroneus longus muscle 63 of the driver 16. In an embodiment the upper and lower edges 56 and 54 of the leg engagement surface are positioned to engage the peroneus longus muscle of the driver 16, a portion of which is shown in outline at 63, thereby inhibiting engagement with tendons, ligaments and bone.

An explanation of a basis for the above mentioned positional restrictions is provided as follows. The leg support 36, and in particular the upper edge 56 of the leg engagement surface 46 acts as a fulcrum about which a moment is exerted by the upper leg 22 as gravity urges the upper leg 22 and knee 24 to splay laterally outwardly towards the center console 14, as shown in FIG. 6. This moment is resisted in part by a moment exerted in the opposite direction about the fulcrum by frictional engagement between the foot 30 of the driver 16 and the vehicle floor 31, and in part by the driver 16 him/herself using his/her leg muscles to resist the urging by gravity. By positioning the upper edge 56 of the leg engagement surface 46 above the halfway point 60 the amount of force that needs to exerted by the leg muscles of the driver 16 to resist gravity and by the frictional engagement between the foot 30 and the vehicle floor 31 is reduced. By positioning the upper edge 56 of the leg engagement surface 46 below the superior epiphysis 62 and by positioning the lower edge 54 above the lateral malleolus 58, engagement between the leg engagement surface 46 is avoided against bone. By positioning the upper and lower edges 56 and 54 of the leg engagement surface 46 to engage the peroneus longus muscle 63, engagement of the leg engagement surface 46 is inhibited with tendons, ligaments and bone.

It will be noted that the leg engagement member 40 is positioned to engage the lateral face of the leg 20a and substantially avoids engagement with the posterior and anterior faces of the leg 20a. This provides the driver 16 with freedom of movement of the leg 20a fore and aft in the vehicle 10. By contrast, supporting the anterior face of the lower leg 26 of the driver 16 may be unduly restrictive on the freedom of movement of the driver 16. For example, in embodiments wherein the vehicle 10 is equipped with cruise control, the driver 16 may wish to move their leg aftwardly so as to rest their foot 30 on the vehicle floor 31 immediately aft of the accelerator and brake pedals 32a and 32b, while the cruise control maintains the speed of the vehicle 10. With a leg support that engages the posterior portion of the lower leg, the driver 16 would find it difficult to move their leg 20a sufficiently aftwardly to avoid contact with the accelerator and brake pedals 32a and 32b.

While the leg engagement member 40 has been shown to be extendable from the leg support base 38 it is optionally possible to provide a leg engagement member 40 that is non-extendable and is integral with the leg support base 38, thereby providing a non-adjustable embodiment of the leg support 36.

While the leg support base 38 has been shown to be adherable to the center console 14 it is alternatively possible for the leg support base 38 to connect to the center console by any other means, such as by being molded as part of the trim panel shown at 64 on the center console 14. In such an embodiment, the leg support 36 would be permanently connected to the center console 14.

In an example, the leg support 36 may be positioned so that the upper edge 56 of the leg engagement surface 46 is less than 13.5 inches above the vehicle floor 31, which represents the bottom of the superior epiphysis 58 in an example of a vehicle driver 16 who is about 70 inches tall and whose lower leg 26 is positioned so that the foot 30 can depress the accelerator pedal 32a. In this example, the upper edge 56 of the leg engagement surface 46 is more than about 10 inches above the vehicle floor 31 which represents the approximate midpoint 60 on the fibula 59 for the aforementioned example driver 16. The lower edge 54 of the leg engagement surface 46 is positioned more than about 4 inches above the vehicle floor 31 which represents the upper end of the lateral malleolus 62 for the aforementioned example driver 16.

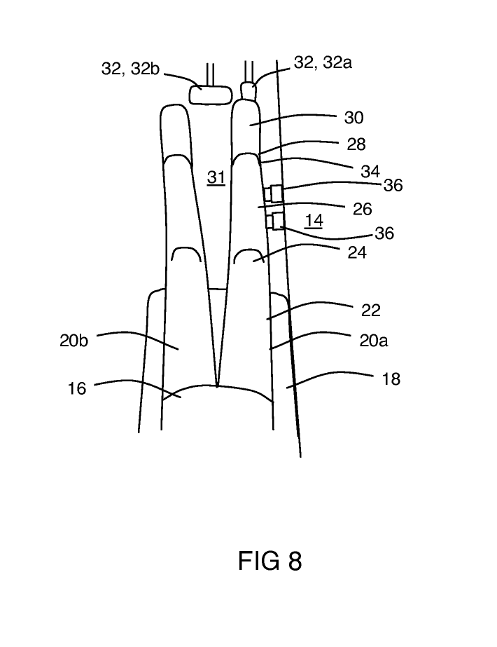

While a single leg support 36 has been shown supporting the driver's leg in FIGS. 3, 6 and 6a it will be understood that a plurality of such devices could be used. An example of the use of a plurality of such leg supports 36 is shown in FIG. 8. Where a plurality of such leg supports 36 are used, one or more of the leg supports 36 may be positioned with an upper edge 56 above the midpoint 60 of the driver's fibula 59 and below the superior epiphysis 62.

While the leg support 36 has been described for use by a driver of a vehicle, the leg support 36 may be usable by any occupant of a vehicle such as the front passenger.

While the leg support 36 has been described as being associated with the center console 14 of the vehicle 10 it is alternatively or additionally possible for the leg support 36 to be mounted to other components of the vehicle, such as the vehicle door, the dashboard, the seat or some other component.

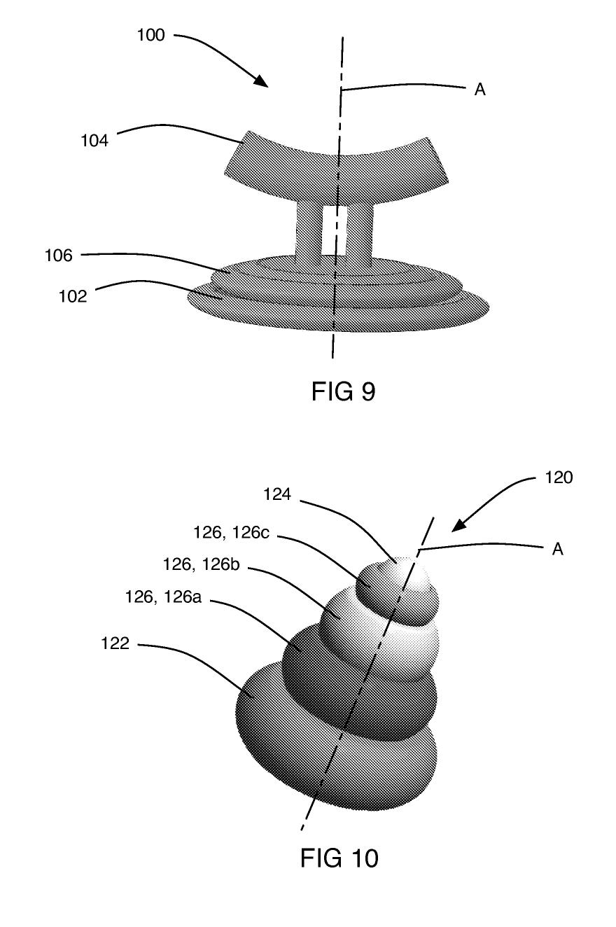

While the leg support 36 has been shown in FIG. 4 to be made up of two telescoping members 38 and 40, other configurations are possible. Referring to FIG. 9 a leg support member 100 is shown that includes a leg support base 102, a leg engagement member 104 and one or more intermediate members. In the embodiment shown in FIG. 9, one intermediate member 106 is shown. The member 106 may be extendable from the leg support base 102. Such extendability may be provided by any suitable means, such as by a friction fit mounting of the member 106 in the support base 102. The leg engagement member 104 may itself be extendable from the intermediate member 106 and may be mounted thereto via friction fit. With this mounting arrangement the engagement member 104 is adjustable in position relative to the base by virtue of the extendability of the intermediate member 106 from the support base 102 and further by the extendability of the engagement member 104 from the intermediate member 106.

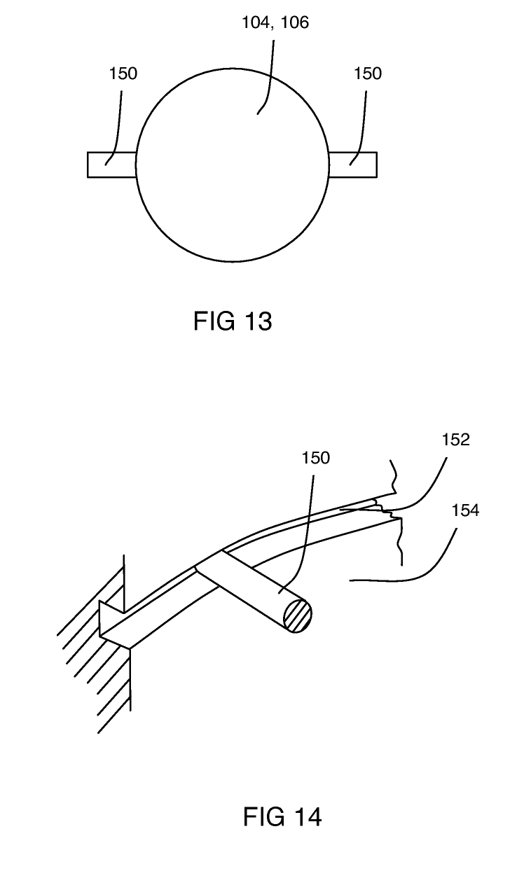

As an alternative to a friction fit mounting other ways of mounting the elements 106 and 104 to the support base 102 may be used. For example, the intermediate member 106 may have arms 150 (see FIG. 13) that extend radially from its periphery. As shown in FIG. 14, these arms 150 may extend into a ‘thread’ 152 (i.e. a helical groove that snugly fits the arms 150) in the inner surface (shown at 154) of the support base 102, so that rotation of the intermediate member 106 about support base axis A permits the member 106 to extend or retract axially. The leg engagement member 104 may have a similar mounting to the intermediate member 106.

If the member 104 has two arms that are positioned diametrically opposite each other about the periphery of the member 104, and if the arms are generally cylindrical, the member 104 may be able to be tilted to cup or engage the leg at a selected angle. To faciliate this, the bottom of the member 104 may be generally shaped with an arcuate (i.e. part-spherical or part-cylindrical) shape so as to ensure that the bottom of the member 104 is not obstructed from tilting by the sides of the intermediate member 106. The arms need not be cylindrical however, and the member 104 need not be capable of being tilted. The arms, particularly if the engage the ‘thread’ with a large amount of surface area, would inhibit the member 104 from threading inwardly towards a retracted position as a result of the force applied to it from the driver's leg 20.

The leg engagement member 104 in FIG. 9 may have any suitable structure. In the embodiment shown in FIG. 9, the engagement member 104 may be made from a closed cell foam material that has a rigid internal skeleton therein.

Another embodiment that incorporates a similar mounting arrangement between successive elements is shown at 120 in FIG. 10. The leg support 120 includes a leg support base 122, a leg engagement member 124, and three intermediate members 126 (shown individually at 126a, 126b and 126c). Each of the members 126 may mount to each other and to the support base 122 in a similar way described above in relation to the leg support 100. However, the leg engagement member 124 may be generally spherical and may be captured in the third intermediate member 126c above its great circle, thereby preventing it from escaping from the intermediate member 126c. However, the leg engagement member 124 may be sufficiently loosely captured that it can roll in place if a tangential force is applied to it. By permitting it to roll, if the vehicle occupant moves their leg 20 forwards or backwards while their leg 20 is engaged with the engagement member 124, the leg engagement member 124 can roll as necessary to accommodate the movement.

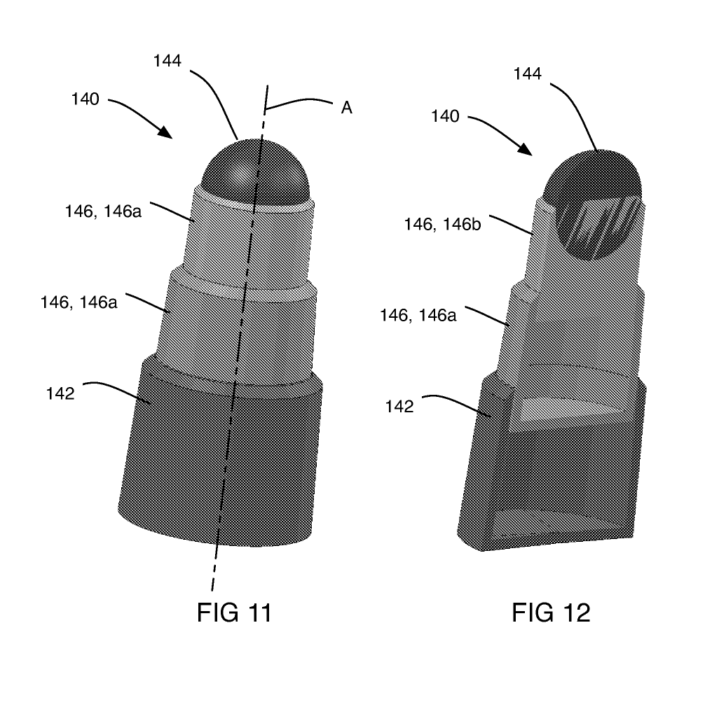

Another embodiment of the leg support is shown at 140 in FIGS. 11 and 12. The leg support 140 includes a leg support base 142, a leg engagement member 144, and two intermediate members 146 (shown individually at 146a and 146b). The intermediate members 146 may telescope outwards and may be held in position by any suitable means, such as by friction. Alternatively, the intermediate members may each include the aforementioned arms 150 which may engage an internal ‘thread’ or helical groove 152 on an inner surface 154 of the member 146b or on the leg support base 142. The leg engagement member 144 may be similar to the leg engagement member 124 shown in FIG. 10, and may be captured in the intermediate member 146b sufficiently loosely to permit it to roll when a tangential force is applied to it from the driver's leg 20.

It may be desirable to adjust the position of the leg support without having to entirely remove and re-attach the leg support in another location.

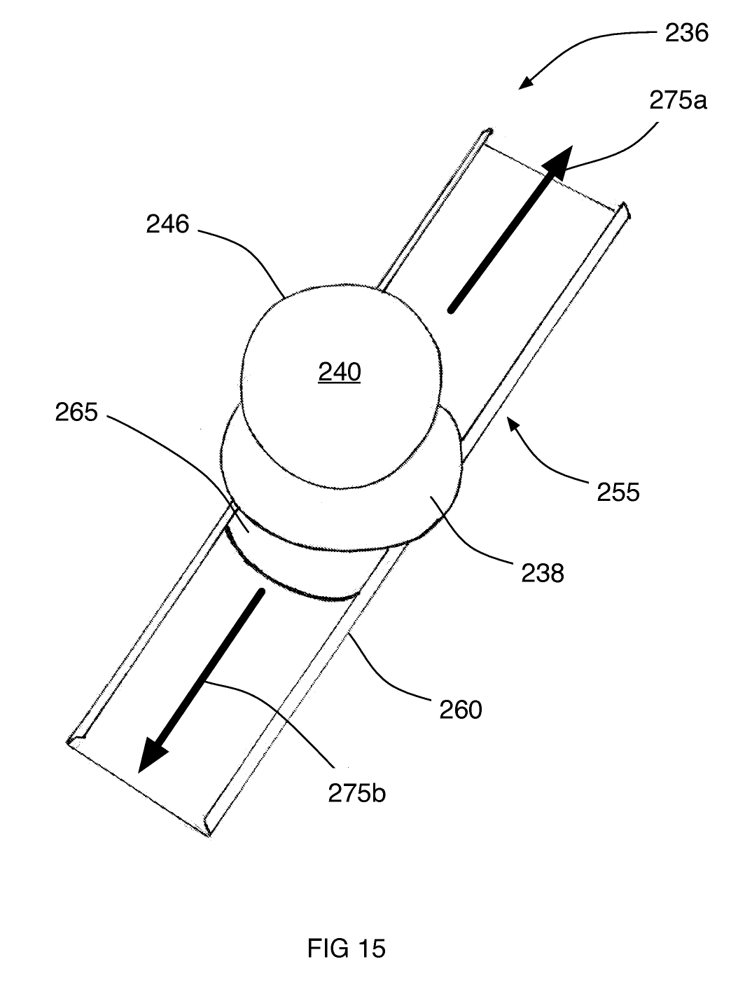

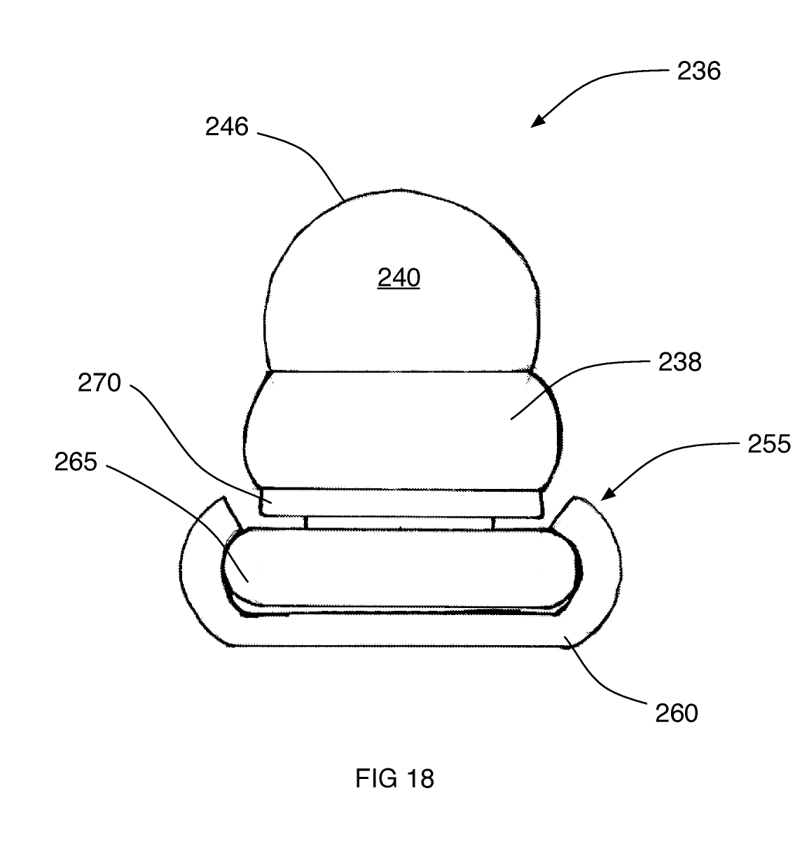

FIGS. 15 to 18 show a leg support 236 configured to be re-positionable relative to the center console 14, and in which like or similar elements depicted in FIGS. 1 to 14 are indicated with like or similar numerals.

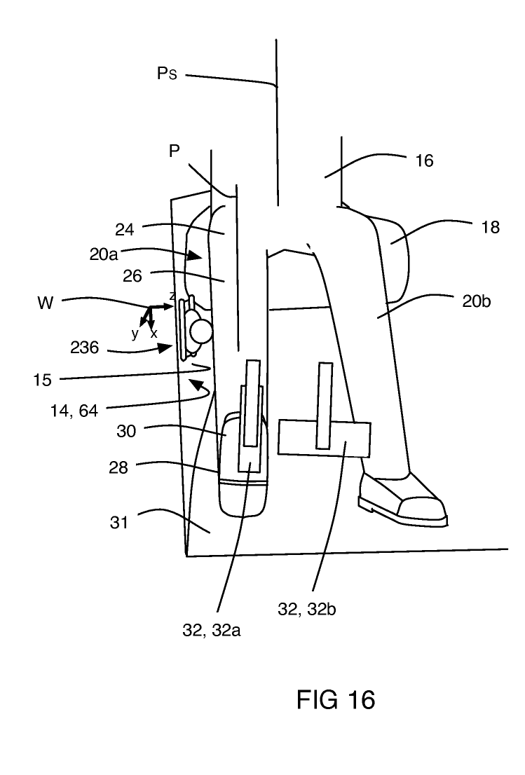

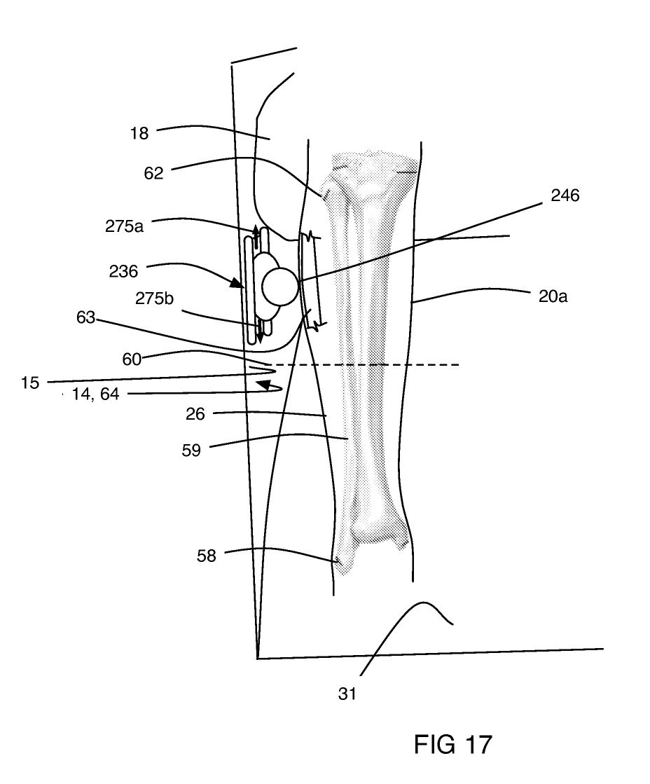

Leg support 236 has leg support base 238 and a leg engagement member 240 that is adjustable in position relative to the leg support base 238 (FIG. 15). Similar to leg support 36, the leg engagement member 240 has a leg engagement surface 246 that extends generally parallel to a sagittal plane Ps of a vehicle occupant in a vehicle's seat, such as vehicle driver 16 in the driver's seat 18 (FIGS. 15 and 16). Leg engagement surface 246 is positioned to engage the laterally outer face of lower leg 26 of vehicle driver 16. Specifically, leg engagement surface 246 is positioned to engage the lower leg 26 above the lateral malleolus (shown at 58) of the fibula (shown at 59) and above a midpoint (i.e. a halfway point) shown at 60 of the fibula 59 and below the superior epiphysis 62 (see FIG. 17).

As with leg support 36, leg support 236 is positionable to support the lower leg 26 in such a way that the upper leg 22 and the lower leg 26 extend in a common plane P that is substantially parallel to the sagittal plane Ps (FIG. 16).

As shown in FIGS. 15 to 18, leg support 236 includes a guide 255 that is configured to mount to center console 14 in a selected position relative to a vehicle seat, such as driver's seat 18. The guide 255 may be mounted or connected to the center console 14 of the vehicle 10 in any suitable way. For example, in an embodiment, the guide 255 may removably connect to the center console 14 by way of an adhesive, thereby permitting the leg support 236 to be purchased as an after-market item by the owner of the vehicle 10. In another embodiment, the guide 255 may be permanently connected to the center console 14, optionally being installed by the vehicle manufacturer during assembly of the vehicle 10 or as an aftermarket item. Furthermore, guide 255 may be configured to mount to a side wall 15 of the center console 14 in an orientation generally parallel to the side wall denoted by axes W (FIG. 16).

Leg support base 238 is slidably mounted to the guide 255, which allows the guide 255 to provide adjustment of a position of the leg engagement member 246 through sliding movement of the leg support base 238 relative to the guide 255.

In the embodiment shown in FIGS. 15 to 18, guide member 255 comprises linear track 260. In order to slidably mount leg support base 238 to the guide 255, guide engagement member 265 is attached to leg support base 238 via guide engagement member connector 270. As shown in FIG. 15, leg support base 238, along with leg engagement member 240, is able travel along linear track 260 in either first direction 275a or second direction 275b.

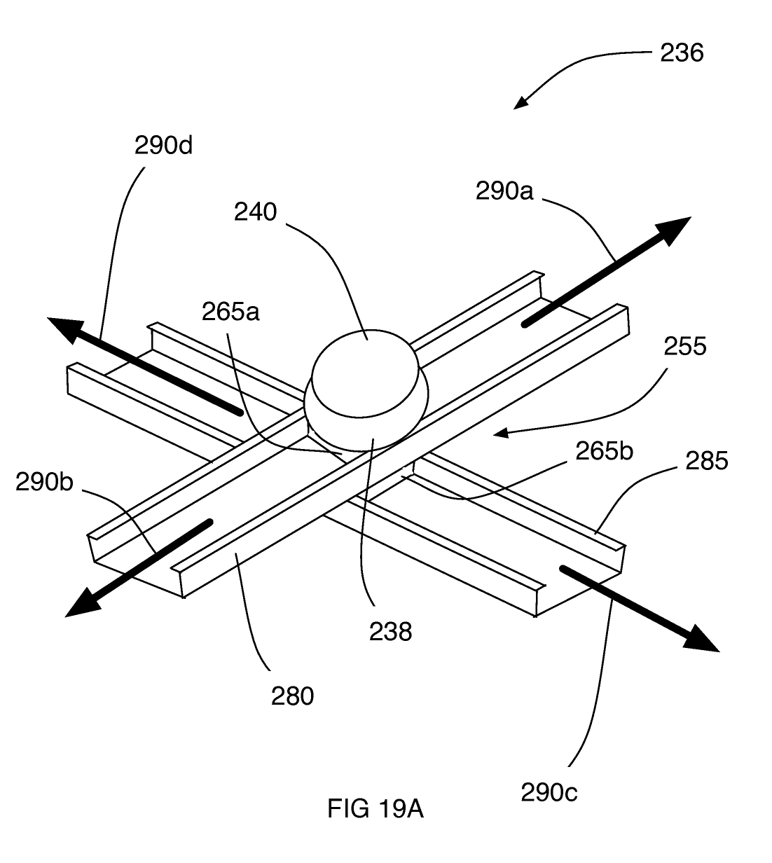

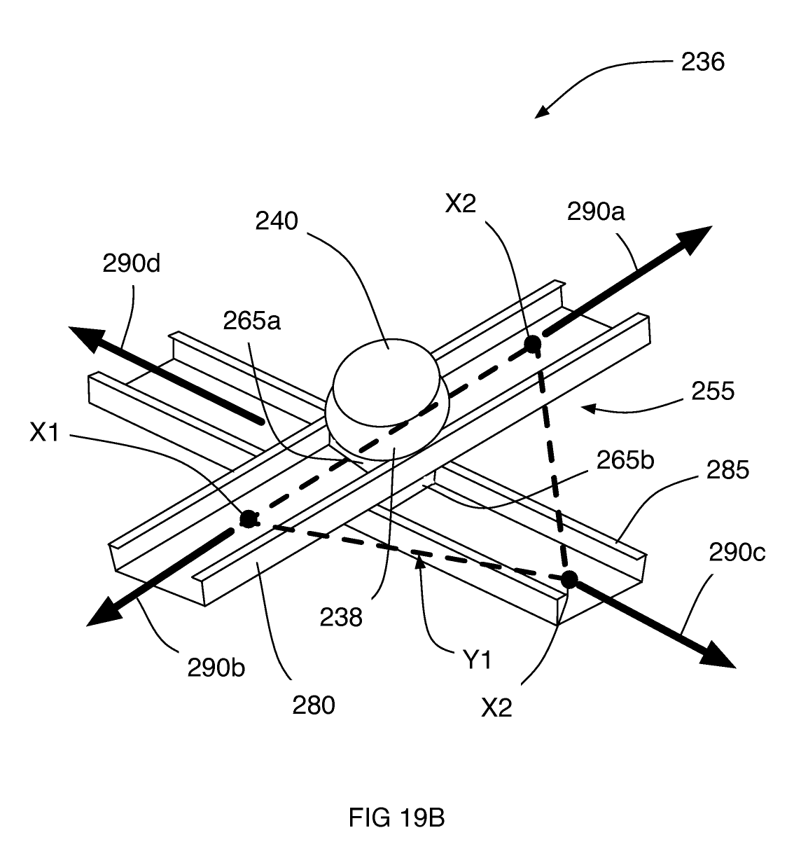

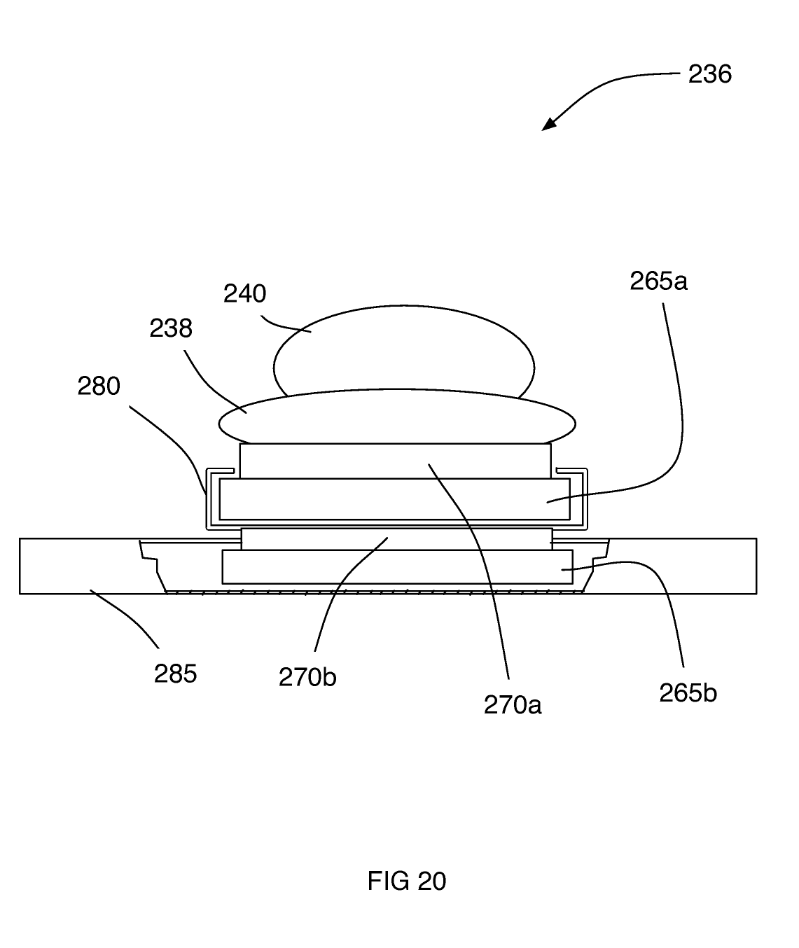

In some embodiments, guide 255 includes more than one linear track configured for sliding movement of the leg support base 238. For example, as shown in FIGS. 19A, 19B and 20, guide 255 can include two linear tracks, first linear track 280 and second linear track 285. Via guide 255, leg support base 238, along with leg engagement member 240, can move in a plurality of directions. For example, leg support base 238, along with leg engagement member 240, can slide along first liner track 280 in either first direction 290a or second direction 290b. By sliding second linear track 285 relative of first linear track 280, leg support base 238, along with leg engagement member 240, can slide in either third direction 290c or fourth direction 290d.

Since leg engagement base 238 and second linear track 285 are slidable, leg engagement member 240 is positionable across a plurality of positions. For example, as shown in FIG. 19B, through sliding movement of the leg engagement base 238 along first linear track 280 combined with sliding movement of first linear track 280 relative to second linear track 285, the guide 255 is configured to permit movement of the leg engagement member 240 over a space defined by at least three non-collinear locations, such as space Y1 defined by first location X1, second location X2 and third location X3.

Attention is directed to FIG. 20 showing how guide 255 may be configured to permit movement of the leg engagement member 240 over space Y.

Guide engagement member 265a is mounted to leg support base 238 via guide engagement member connector 270a and is configured to slide along first linear track 280. Guide engagement member 265b is configured to slide along second linear track 285, is mounted to first linear track 280 via guide engagement connector 270b.

Being able to adjust, using the guide 255, the position of leg engagement member 240 in any of four directions, namely the first direction 290a, second direction 290b, third direction 290c and fourth direction 290d, allows the vehicle occupant, such as vehicle driver 16, greater control over the desired position of leg engagement member 240 without having to entirely remove and reposition leg support 236.

It is understood that these examples are non-limiting, and guide 255 can include any suitable number of linear tracks in any arrangement suitable to provide adjustment of a position of leg engagement member 240. Furthermore, guide 255 is not limited to linear tracks but may include any device that is configured to provide adjustment of a position of the leg engagement member 236 through sliding movement of the leg support base 238 relative to guide 255. For example, guide 255 may be a roller rail system mounted to leg support base 238.

The leg engagement member 240 may be configured for greater comfort of the vehicle occupant. For example, leg engagement member 240 can be compressible. In some embodiments, leg engagement member is configured to be at least partially filled with one of a gas, a liquid or a gel. For example, leg engagement member 240 may be inflated with air to apply a desired pressure against the lower leg 26. In some embodiments, the leg engagement member 240 may comprise an elastomeric material, such as silicon rubber material.

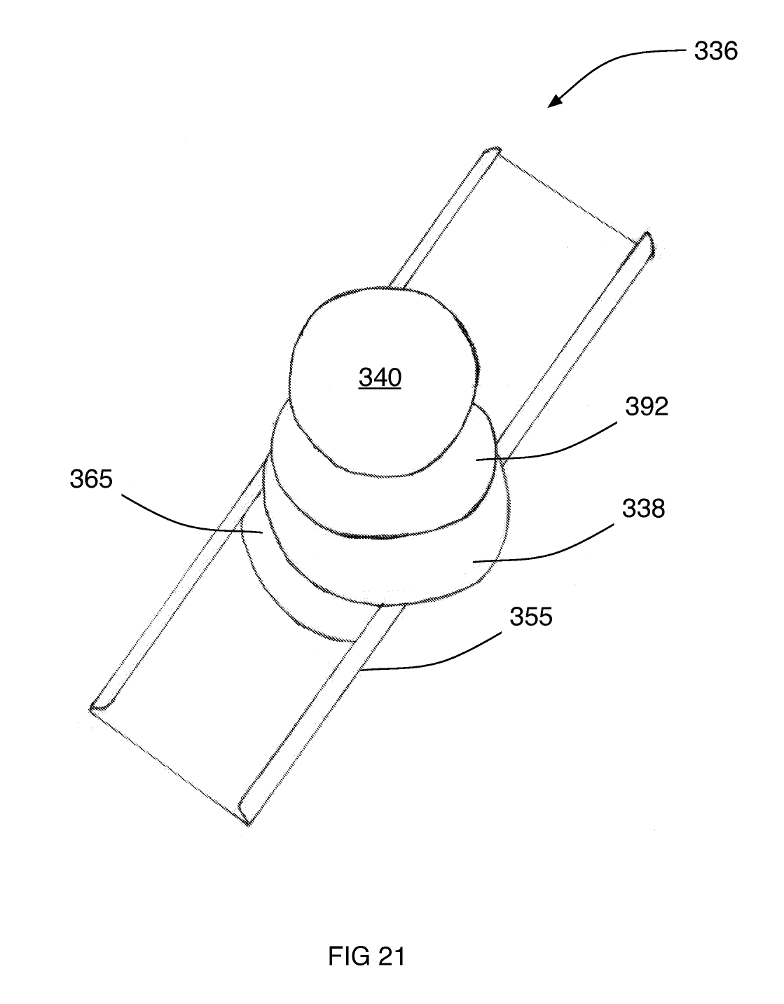

Similarly to leg support 36, the described leg support may include at least one intermediate member. FIG. 21, in which like or similar elements depicted in FIGS. 15 to 19 are indicated with like or similar numerals, shows leg support 336 connected to the leg support base 338 via intermediate member 392. Leg support base 338 is slidably mounted to guide 355 via roller 365. According to some embodiments, leg support 336 includes more than one intermediate member 392. For example, leg engagement member 340 may nest in intermediate member 392, which may nest in a successive intermediate member that is connected to the leg support base 338.

Leg engagement member 340 may be extendable in a direction, such as direction 396, from intermediate member 392 and the intermediate member 392 is extendable in a direction, such as direction 396, from the leg support base 338. Similar to leg support 140, intermediate member 395 may telescope outwards of leg support base 338, or a successive intermediate member, and may be held in place by any suitable means, such as by friction. Alternatively, the intermediate members may each include the aforementioned arms 150 which may engage an internal ‘thread’ or helical groove 152 on an inner surface 154 of intermediate member 392 or the leg support base 338. Furthermore, leg engagement member 340 may be similar to leg engagement member 124 shown in FIG. 10, and may be captured in the intermediate member 392 sufficiently loosely to permit it to roll when a tangential force is applied to it from the driver's leg 20.

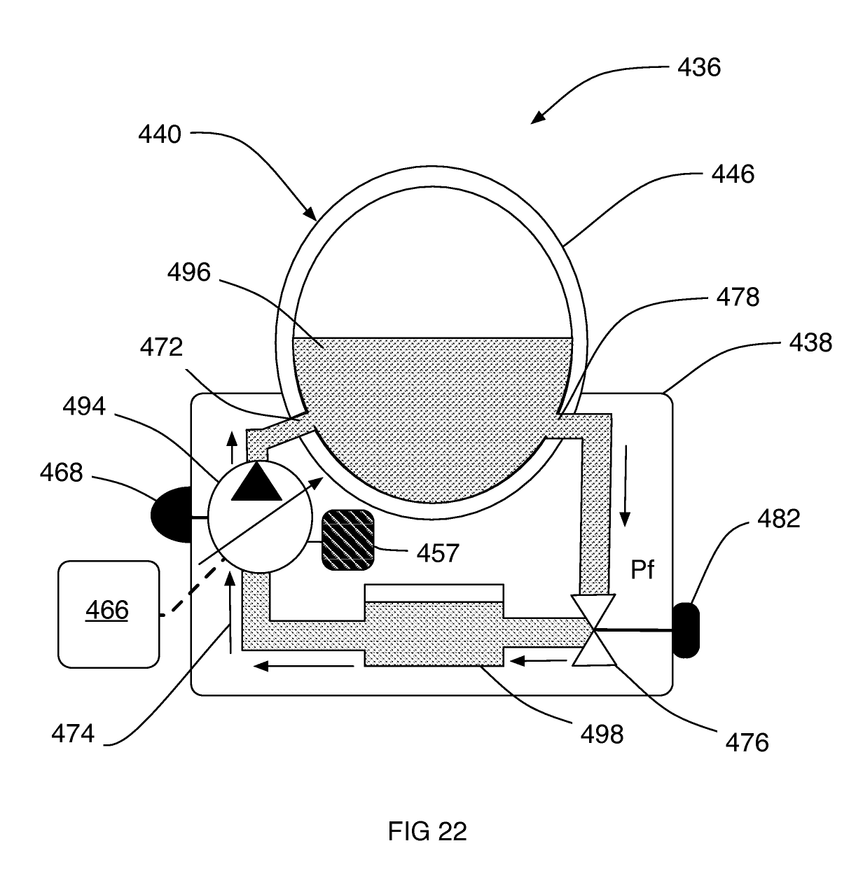

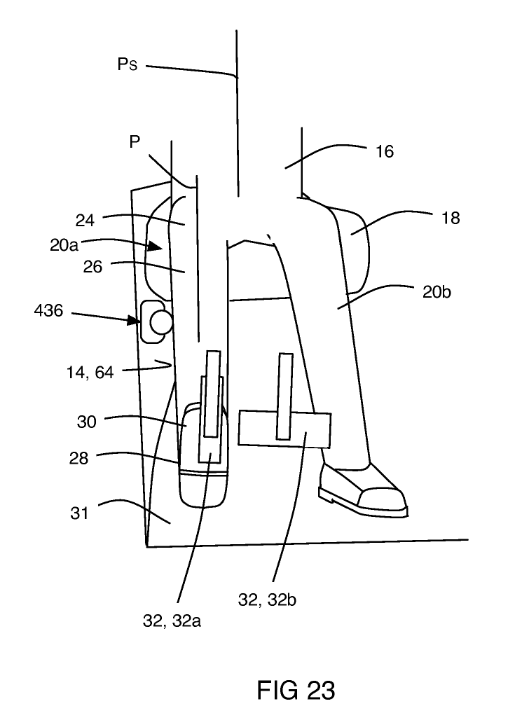

As stated above, the described leg support may include a leg engagement member that is configured for greater comfort of the vehicle occupant. FIGS. 22 to 23, in which like or similar elements depicted in FIGS. 15 to 21 are indicated with like or similar numerals, shows leg support 446 for a vehicle occupant, such as vehicle driver 16, that includes leg support base 438 configured to mount to venter console 14 in a selected position relative to a vehicle seat in a vehicle, such as driver's seat 18 of vehicle 10 (FIG. 1).

Leg support 436 has leg support base 438 and a leg engagement member 440 that is adjustable in position relative to the leg support base 438 (FIG. 22). As shown in FIG. 22, leg engagement member 440 is at least partially hollow. Leg engagement member 440 may comprise an elastomeric material. For example, the leg engagement member 440 may comprise silicone rubber.

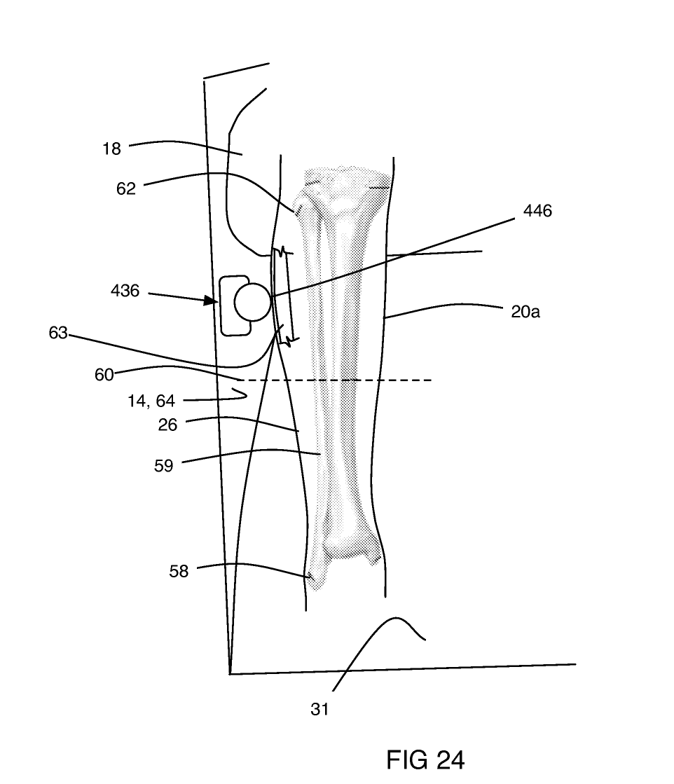

Similar to leg support 36 and leg support 236, the leg engagement member 440 has a leg engagement surface 446 that extends generally parallel to a sagittal plane Ps of a vehicle occupant in a vehicle's seat, such as vehicle driver 16 in the driver's seat 18 (FIGS. 22 and 23). Leg engagement surface 446 is positioned to engage the laterally outer face of lower leg 26 of a vehicle occupant, such as vehicle driver 16. Specifically, leg engagement surface 446 is positioned to engage the lower leg 26 above the lateral malleolus (shown at 58) of the fibula (shown at 59) and above a midpoint (i.e. a halfway point) shown at 60 of the fibula 59 and below the superior epiphysis 62 (see FIG. 24).

As with leg support 36 and leg support 236, leg support 436 is positionable to support the lower leg 26 in such a way that the upper leg 22 and the lower leg 26 extend in a common plane P that is substantially parallel to the sagittal plane Ps (FIG. 23).

Leg support 436 further includes a pump 494 coupled to leg support base 438 that is configured to draw a fluid 496 from a reservoir 498 and to provide the fluid 496 to the leg engagement member 440 to at least partially fill the leg engagement member 440 with the fluid 496. Fluid 496 may comprise at least one of a gas, such as air, a liquid and a gel. Also provided is pump motor 457 for driving the pump 494, which is configured to electrically couple to a power source 466. The pump motor 457 may be any motor suitable for driving pump 494. A pump controller 468 is provided for actuating the pump 494 and, in some embodiments, to allow a vehicle occupant, such as vehicle driver 16, to vary the amount of fluid 496 provided by pump 494 to the leg engagement member 440. Pump controller 468 may, for example, comprise one of a knob, a switch and a button.

Leg engagement member 440 has at least one orifice, such as orifice 472, coupled to pump 494. Pump 494 provides fluid 496 to the leg engagement member 440 orifice 472 to at least partially fill the leg engagement member 440.

In the embodiment shown in FIG. 22, pump 494 may be a hydraulic pump that is configured to provide fluid 496 to leg engagement member 440 in one direction, such as direction 474. A vehicle occupant may want to reduce the pressure applied by leg engagement member 440 against lower leg 26 and therefore want to reduce the amount of fluid 496 in leg engagement member 440. In order to reduce the amount of fluid 496 in leg engagement member 440, relief valve 476, coupled to orifice 478 of the leg engagement member 440, may be provided to allow at least a portion of fluid 496 to travel back to reservoir 498. In some embodiments, relief valve 476 may open under a predetermined pressure Pf of fluid 496 against the relief valve 476. In some embodiments, relief valve 476 may be actuated by valve actuator 482.

FIG. 23, in which like or similar elements depicted in FIGS. 22 to 24 are indicated with like or similar numerals, shows pump 594 as a hydraulic pump configured to adjustably provide a volume of fluid 596 to leg engagement member 540. Pump 594 is coupled to at least one orifice of the leg engagement member 540, such as orifice 572. As shown, pump 594 is configured to direct the flow of fluid 596 in two directions, first direction 584 and second direction 586. When pump 594 directs the flow of fluid 596 in the first direction 584, fluid 596 is provided to the leg engagement member 540 through at least one orifice, such as orifice 572, to at least partially fill the leg engagement member 540. When pump 594 directs the flow of fluid 596 in the second direction 586, fluid 596 is drawn from the leg engagement member 596 and provided to the reservoir 598. In some embodiments, pump controller 568 comprises an adjustable knob that is configured to actuate and vary the flow direction of fluid 596 provided by pump 594. Furthermore, pump motor 557 for driving the pump 494, configured to electrically couple to a power source 566, may be any motor suitable for driving pump motor 594.

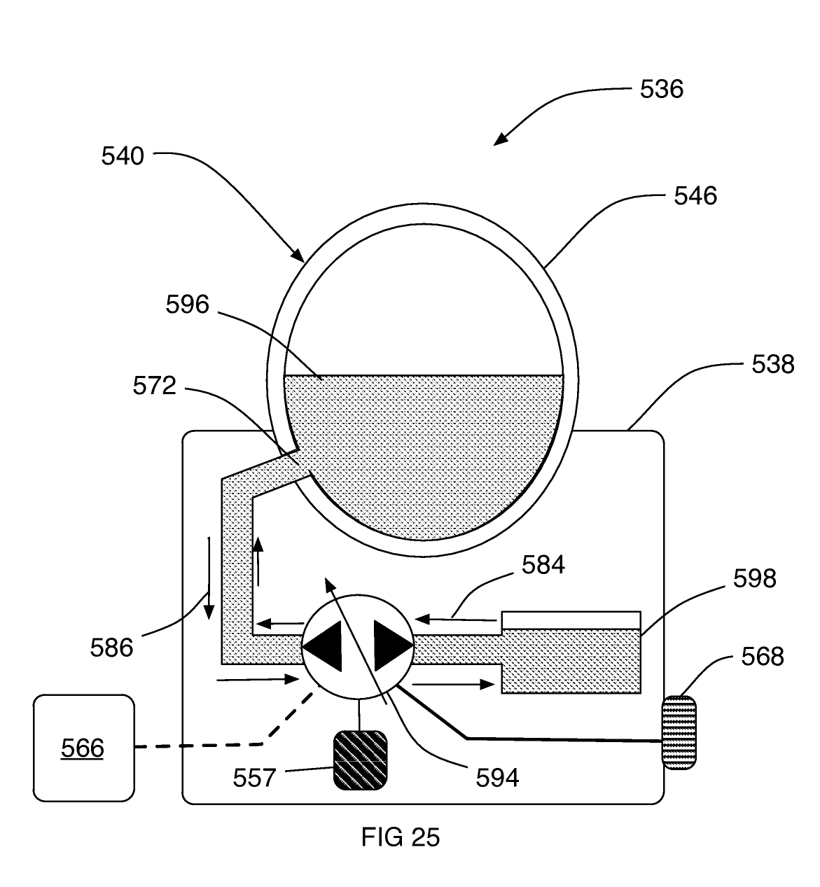

Although FIGS. 22 to 25 depict pump 494, pump 594, reservoir 494, reservoir 594, pump 457 and pump motor 557 as retained within the leg support base 438 and leg support base 538, it is understood that in some embodiments one or more of these components may be located exterior of leg support base 438 and leg support bade 538. For example, reservoir 498 may comprise an interior space of the vehicle 10, such as a passenger compartment 12. Hence, in some embodiments, fluid 496 would comprise air from the interior space of the vehicle 10. In some embodiments, pump 494 would be coupled to an air intake to draw air from the interior space of the vehicle 10, passenger compartment 12, as fluid 496. According to related embodiments, orifice 478 can be exposed to an interior space of vehicle 10 and relief valve 476 may comprise a removable plug for orifice 478.

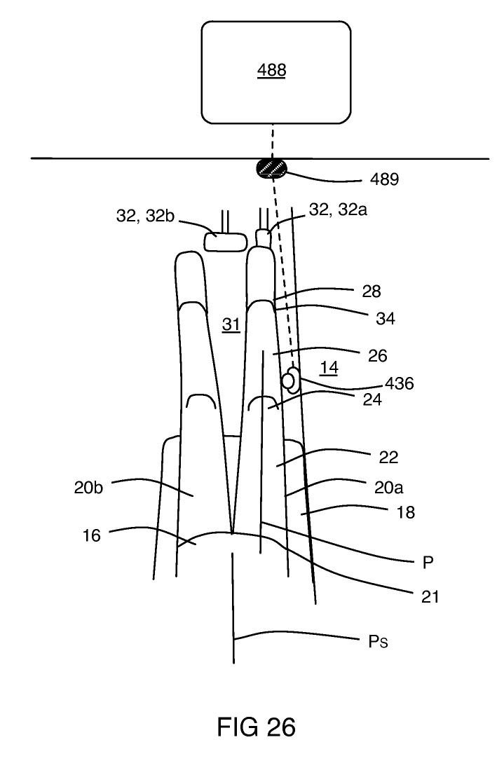

Furthermore, power source 466 and power source 566 can be any power source suitable for providing electrical energy to operate pump 494 and pump 594. For example, power source 466 can comprise at least one battery. As another example, power source 466 can comprise a vehicle accessory power source 488 of vehicle 10, such as the engine or battery of vehicle 10 (see FIG. 26). Pump 466 may be electrically coupled to the vehicle accessory power source 488 via an in-vehicle power receptacle 489. In some embodiments, the in-vehicle power receptacle 489 comprises a 12-volt direct current outlet.

While the above describes one or more particular embodiments, it will be appreciated that modifications and variations may be made to the embodiments described herein without departing from the proper scope of the claims appended hereto.

1. A leg support for a vehicle occupant, comprising:
a leg support base;
a leg engagement member that is adjustable in position relative to the leg support base,
wherein the leg engagement member has a leg engagement surface that extends generally parallel to a sagittal plane of a vehicle occupant in the vehicle seat so as to be positioned to engage the laterally outer face of a lower leg of the vehicle occupant, wherein the leg engagement surface is positioned to engage the lower leg of the vehicle occupant above the lateral malleolus of the fibula of the vehicle occupant and to engage the lower leg of the vehicle occupant above a midpoint of the fibula and below the superior epiphysis of the fibula, and wherein the leg engagement member is positionable to support the lower leg of the vehicle occupant in such a way that the upper leg and the lower leg extend in a common plane that is substantially parallel to the sagittal plane of the vehicle occupant; and
a guide configured to mount to a center console in a selected position relative to a vehicle seat in a vehicle, the leg support base being slidably mounted to the guide, and the guide being configured to provide adjustment of a position of the leg engagement member through sliding movement of the leg support base relative to the guide.

2. The leg support as claimed in claim 1, wherein the guide is configured to permit movement of the leg engagement member over a space defined by at least three non-collinear locations.

3. The leg support as claimed in claim 1, wherein the guide is configured to mount to a side wall of the center console in an orientation generally parallel to the side wall.

4. The leg support as claimed in claim 1, wherein the guide comprises at least one linear track configured for sliding movement of the leg support base relative to the guide.

5. The leg support as claimed in claim 1, wherein the leg engagement member is compressible.

6. The leg support as claimed in claim 5, wherein the leg engagement member is configured to be at least partially filled with one of: a gas; a liquid; and a gel.

7. The leg support as claimed in claim 1, wherein:
the leg engagement member is connected to the leg support base via at least one intermediate member, and
the leg engagement member is extendable in a direction from the at least one intermediate member and wherein the at least one intermediate member is extendable in the direction from the leg support base.

8. The leg support as claimed in claim 1, wherein the leg engagement member comprises a silicon rubber material.

9. A leg support for a vehicle occupant, comprising:
a leg support base configured to mount to a center console in a selected position relative to a vehicle seat in a vehicle;
a leg engagement member that is adjustable in position relative to the leg support base,
wherein the leg engagement member has a leg engagement surface that extends generally parallel to a sagittal plane of a vehicle occupant in the vehicle seat so as to be positioned to engage the laterally outer face of a lower leg of the vehicle occupant, wherein the leg engagement surface is positioned to engage the lower leg of the vehicle occupant above the lateral malleolus of the fibula of the vehicle occupant and to engage the lower leg of the vehicle occupant above a midpoint of the fibula and below the superior epiphysis of the fibula, and wherein the leg engagement member is positionable to support the lower leg of the vehicle occupant in such a way that the upper leg and the lower leg extend in a common plane that is substantially parallel to the sagittal plane of the vehicle occupant;
a pump coupled to the leg support base and configured to:
draw a fluid from a reservoir, and
provide the fluid to the leg engagement member to at least partially fill the leg engagement member;
a pump motor for driving the pump, the pump motor being configured to electrically couple to a power source for the pump; and
a pump controller;
wherein the leg engagement member has at least one orifice coupled to the pump through which the fluid is provided to the leg engagement member.

10. The leg support as claimed in claim 9, wherein the fluid comprises at least one of: a gas; a liquid; and a gel.

11. The leg support as claimed in claim 9 further comprising a relief valve for allowing at least a portion of the fluid in the leg engagement support member to flow to the reservoir, the relief valve being coupled to another one of the at least one orifice of the leg engagement member.

12. The leg support as claimed in claim 9, wherein the pump is configured to adjustably provide a volume of the fluid to the leg engagement member.

13. The leg support as claimed in claim 12, wherein the pump controller comprises an adjustable knob.

14. The leg support as claimed in claim 9, wherein the pump controller comprises one of: a knob; a switch; and a button.

15. The leg support as claimed in claim 9, wherein the power source comprises a vehicle accessory power source.

16. The leg support as claimed in claim 15, wherein the pump is electrically coupled to the vehicle accessory power source via an in-vehicle power receptacle.

17. The leg support as claimed in claim 16, wherein the in-vehicle power receptacle comprises a 12-volt direct current outlet.

18. The leg support as claimed in claim 9, wherein the power source comprises at least one battery.

19. The leg support as claimed in claim 9, wherein the reservoir comprises an interior space of the vehicle and the fluid comprises air from the interior space.

20. The leg support as claimed in claim 9, wherein the leg engagement member comprises silicon rubber.
